(19) United States
(12) Patent Application Publication
(10) Pub. No.: US 2003/0036355 A1
(43) Pub. Date: Feb. 20, 2003

(54) Method for electronically paying for the use of a means of transportation, associated monitoring methods and associated units

(76) Inventor: Michael Gundlach, Muenchen (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/208,017

(22) Filed: Jul. 31, 2002

(30) Foreign Application Priority Data
Aug. 1, 2001 (EP) 01118545.1

(51) Int. Cl. H04B 5/00

(52) U.S. Cl. 455/41; 455/39

(57) ABSTRACT

A system and method in which a cell phone includes a mobile phone interface, a local interface and a memory card. Use data which indicate the planned use of a means of transportation by the user of the cell phone is transmitted via the local interface. In addition, an electronic payment method is executed using the cell phone.

### CLAIM FOR PRIORITY

This application claims priority of European application 01118545.1 filed on Aug. 1, 2001.

### TECHNICAL FIELD OF THE INVENTION

The invention relates to a system and method in which a terminal of a mobile phone data transmission network is conveyed together with the user of the terminal in a means of passenger transport.

### BACKGROUND OF THE INVENTION

The terminal, which is also referred to as a cell phone, is assigned a call number at which other terminals in the mobile phone network can access it. The terminal contains a mobile phone interface and a memory card in which the call number of the terminal is stored. The memory card is also referred to as a chip card or SIM card (Subscriber Identity Module). The means of transportation is an aircraft, a ship or a vehicle, for example a bus, or a rail vehicle such as an underground train, a local train or a tram.

A known method for electronically paying for the use of a means of transportation is known from the Internet, cf. the web page with the address: http://www.ic.siemens.com/mobile/payment/payment scenarios/ticketing.html. In the “mobile ticketing” method developed by Siemens AG, Information and Communication Division, it is necessary to dial the call number of the transportation company via the mobile phone network in order to acquire a ticket. A specific ticket can then be selected using selection menus. As soon as the inquiry is confirmed, for example after the execution of a payment procedure, the electronic ticket is sent, as an SMS, to the terminal of the passenger together with the date, the time, a data item relating to the type of ticket and a code number. When tickets are checked, all that is necessary is to show the inspector the SMS on the display unit of the terminal. Payment can be made using a series of different payment methods, for example payment by means of the telephone bill or by means of a method with prepayment. Solutions for electronic payment methods are also offered by Siemens AG, Information and Communication Division.

The known “mobile ticketing” method is in particular also suitable for passengers who do not have the local currency. In addition, it is not necessary to print out tickets.

### SUMMARY OF THE INVENTION

The invention discloses a system and method for electronically paying for the use of a means of transportation which is in particular simple and user-friendly. In addition, associated reliable monitoring methods and associated units are to be specified.

Although systems and methods for electronically paying for the use of a means of transportation using a cell phone have several advantages, the ticket is made unnecessarily expensive by the use of the mobile phone network. On the other hand, cell phones have already had interfaces for local data transmission, for example via connecting cables to another computer, for a long time. Local data transmission means that the data is transmitted over a short distance in comparison to the length of the mobile phone link according to the protocol provided for the local interface. The powerfulness of the local interface and the number of cell phones which are equipped with identical local interfaces is rising from year to year. In contrast to the transmission of data via a mobile phone interface, the transmission of data via a local interface is not charged for. For this reason, in the invention the local interface is included in the payment method.

According to one embodiment of the invention, a short-range data transmission link is set up between the terminal and a service provider computer via the local interface. Use data, for example data relating to a journey or data relating to a flight, which indicate the planned use of the means of transportation by the user of the terminal is transmitted from the terminal to the service provider computer via the short-range data transmission link. The electronic payment method is also executed using the local interface.

The invention provides that the data necessary for buying the ticket is transmitted via the local interface, for whose use, in contrast to a data transmission network, it is not necessary to pay a network operator. The use of the local interface also permits electronic payment even in the event of a fault or of overloading of the mobile phone network as well as under poor reception and transmission conditions as frequently occur in the vicinity of railroad stations and in particular in underground stations of underground railroads.

Apart from a cell phone, the passenger does not require any additional device to purchase the ticket. However, the passenger carries the cell phone in any case. Although the actual main function of the cell phone, i.e. permitting access to a mobile phone network, is not used in the method according to the invention, many components of the cell phone which provide functions for using the mobile phone network, are also used for purchasing the ticket, for example the power supply, the display unit, a storage unit and a processor.

In one embodiment of according to the invention, the call number of the terminal is transmitted to the service provider computer via the short-range data transmission link and stored in a central storage unit together with the use data.

In order to monitor the actual use of the means of transportation by the user of the terminal, in another embodiment a monitoring data transmission link is set up between a monitoring device, which is operated by monitoring personnel, and the terminal via the local interface. The call number of the terminal is transmitted to the monitoring device via the monitoring data transmission link. In addition, a long-distance data transmission link is set up between the monitoring device and the central storage unit. The call number of the terminal is transferred via the long-distance data transmission link to a service provider computer which has access to the central storage unit. The use data which is stored in relation to the call number is read in the service provider computer. The actual use of the means of transportation is checked in the service provider computer or in the monitoring device by reference to the read use data. In this embodiment, the use data does not need to be stored in the terminal. However, storage as a receipt for the passenger is preferable. By storing the data in the central storage unit or at two different locations, unauthorized changes to the data are made more difficult and can easily be discovered. In the embodiment, the call number of the terminal is easily transmitted from the terminal to the monitoring device without a data transmission link which is to be paid for having to be set up via the mobile phone network. Manual transmission of the call number would be very awkward and also very susceptible to errors involving transposition of numbers and typing errors.

In an alternative embodiment according to the invention, confirmation data, which includes a confirmation relating to the electronic payment method, is transmitted from the service provider computer to the terminal via the short-range data transmission link. The confirmation data is stored in the memory card of the terminal. Confirmation data serves as an acknowledgement of the payment procedure and can also be used in monitoring the actual use of the means of transportation.

In another embodiment, a monitoring data transmission link is set up between the terminal and a monitoring device, which is operated by monitoring personnel, via the local interface. The confirmation data is then transmitted from the terminal to the monitoring device via the local interface. The correspondence of or the discrepancy between the planned use and actual use of the means of transportation is then checked in the monitoring device by reference to the confirmation data. The monitoring method can be carried out using the call number of the terminal, but also independently of the call number.

In still another embodiment, the confirmation data includes the use data. However, a check number from the use data is also calculated in accordance with a method which is kept secret by the operator of the means of transportation and used as confirmation data, in addition to the use data or instead of the use data.

In yet another embodiment according to the invention, the use data indicates the place of embarkation, a place of disembarkation and a time when the payment method is carried out. In one alternative, the use data includes not only the place of embarkation but also a number of tariff zones whose use is planned, as well as the time at which the payment method has been carried out. However, it is also possible to use other use data, for example if methods with subsequent endorsement of tickets are used.

In another embodiment according to the invention, the use data and/or the confirmation data is transmitted encrypted and/or signed by the respective transmitter. In particular, asymmetrical encryption methods in which public digital keys and private digital keys are used are employed. In one embodiment, the encryption and signature methods are standardized methods, for example according to the standard X.509 of the ITU-t (International Telecommunication Union-Telecommunication Sector). The encryption and/or the signing makes falsification of the use data or confirmation data more difficult.

In still another embodiment according to the invention, the local interface is an interface with a short data transmission range. The range is, for example approximately one meter or a few meters and is preferably approximately 10 m. In one aspect, the local interface is a radio interface, in particular an interface which operates according to the Bluetooth Standard. The Bluetooth Standard was produced at the initiative of Nokia; Ericsson; IBM Intel and Toshiba. Later, well over 200 companies accepted this standard. Using a local interface which operates according to the Bluetooth Standard ensures that an interface is used which is widespread in cell phones and which will still be widespread in cell phones in the future.

In one aspect of the invention, the local interface is an optically operating interface, for example in the infrared range. Interfaces which operate in the radio range or in the optical range do not require any cables for the transmission of the data so that the maneuvers and logistical problems associated with them are avoided.

In another embodiment according to the invention, the data transmission link is set up automatically after the manual inputting of a start signal. Additionally, or alternatively, the data can be transmitted automatically after the inputting of a manual start signal. In particular, if pre-assignments with standard data are stored in the terminal, the actions of the user when purchasing a ticket do not go beyond pressing a button or selecting just one menu item.

In yet another embodiment according to the invention, an electronic prepayment method or a credit payment method is used as the payment method. Both methods have already become widespread and are therefore accepted. The method with prepayment is also referred to as a prepaid method. Alternatively, a method is used in which an amount of money which is stored on the memory card of the terminal is reduced. The use of the payment method which access to the memory card is very well suited in particular to tickets with low prices of a few Deutschmarks. The link is then set up via the mobile phone network only if a relatively large amount of money, for example an amount of 100 DM, has been spent after several journeys.

In another embodiment according to the invention, the use data is transmitted to the service provider computer either via the local interface or via the mobile phone interface as a function of a selection data item. The passenger can make use of the advantages of various methods and avoid the disadvantages of one method by using the other method. In particular, redundancy is created which makes it possible to acquire a ticket even when the mobile phone network fails or is not accessible or when a local service provider computer which is used as an automatic ticket vending machine fails. In the embodiment, the passenger can also select the time at which he would like to buy the ticket. If the passenger decides on the method using the local interface, is preferable to buy the ticket when in the vicinity of a receiver unit which interacts with the local interface. The passenger can also decide whether he pays the additional connection fee when using the mobile phone network which covers a wide area, or whether he prefers to use the local interface in order to acquire the ticket without secondary costs.

The invention also relates to a terminal, a monitoring device and a service provider computer which are used when carrying out the method according to the invention.

### BRIEF DESCRIPTION OF THE DRAWINGS

Exemplary embodiments of the invention are explained below with reference to the appended drawings, in which:

FIG. 1 shows a ticket computer with a Bluetooth Standard interface.

FIG. 2 shows an exemplary procedure of buying a ticket.

FIG. 3 shows an exemplary procedure for monitoring the ticket without involving a mobile phone network.

FIG. 4 shows an exemplary procedure when monitoring the ticket using a mobile phone network.

### DETAILED DESCRIPTION OF THE PREFERRED EMBODIMENTS

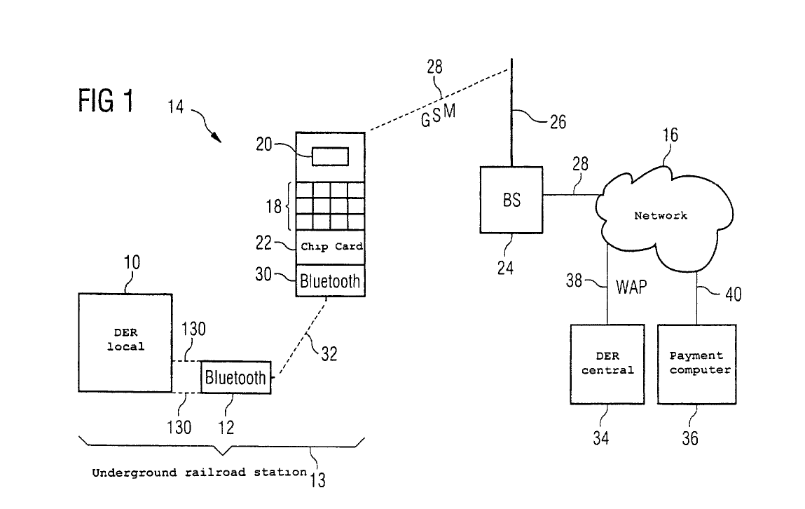

FIG. 1 shows a ticket computer 10 which is equipped with a Bluetooth interface 12 or is connected via a local data transmission network. The ticket computer 10 is located in an underground railroad station which is possibly located several meters under the surface of the ground. A few meters from the Bluetooth interface 12 there is, see bracket 13, a cell phone 14 of a passenger. The cell phone 14 is equipped for operation in a mobile phone network 16, i.e. it contains a keypad 18 for inputting call numbers and also letters, a display unit 20 for displaying a user menu and a chip card 22 on which, inter alia, the call number R1 of the cell phone 14 is stored.

The basis station 24 of the mobile phone network 16 is illustrated in FIG. 1. The base station 24 has an antenna 26 and is connected to the mobile phone network 16 via a line 28. Via a mobile phone interface 28, the cell phone 14 can be accessed by other terminals of the mobile phone network 16 or of a fixed network, and the cell phone 14 can access the other terminals. The data is transmitted via the mobile phone interface 28 using the GSM standard (Global System for Mobile Communication). However, it may be impossible to transmit data via the mobile phone interface 28 in the underground station because the mobile phone interface 28 is disrupted owing to the poor transmission conditions between the cell phone 14 and antenna 26.

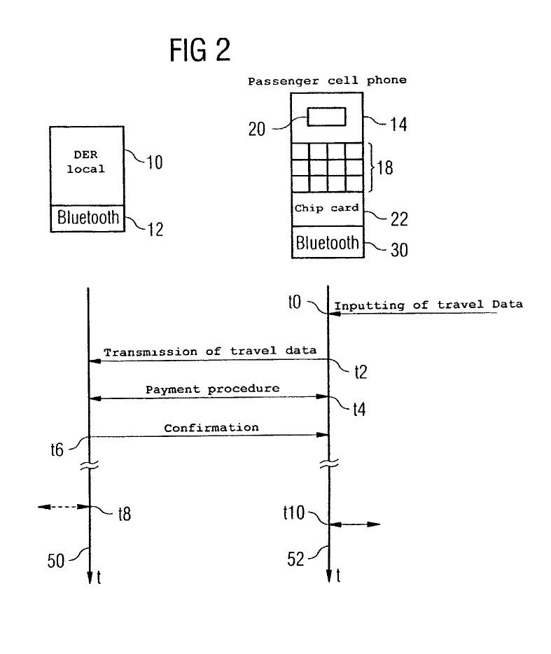

The cell phone 14 also includes a Bluetooth interface 30 which can be used to set up a local data transmission link between the cell phone 14 and the ticket computer 10. The data which is exchanged via the local data transmission link 32 will be explained in more detail with reference to FIG. 2.

In addition, a central service provision computer (DER) 34 and a payment computer 36, which are connected to the mobile phone network 16 via a data transmission line 38 or 40, are illustrated in FIG. 1. The central service provider computer 34 belongs to the operator of the underground railroad and performs central functions during the selling or buying of tickets. The data is transmitted from the service provider computer 34 or to the service provider computer 34 using, for example, protocol INAP (Intelligent Network Application Protocol). The payment computer 36 is used when carrying out customary electronic payment methods, for example when executing a prepaid method.

FIG. 2 shows a procedure when buying a ticket. Two time sequences 50 and 52 show procedures which are executed with the involvement of the ticket computer 10 and with the involvement of the cell phone 14. Later times t are plotted further down on the time sequences 50 and 52 than earlier times t.

At a time t0, the passenger inputs the travel data via the keypad 18 of his cell phone 14. It is assumed that he would like to buy a day pass. The displaying of a selection menu in the display unit 20 is brought about from the ticket computer 10 (not illustrated).

At a time t2, the travel data is transmitted from the cell phone 14 to the ticket computer 10 via the Bluetooth interfaces 30 and 12. A travel price associated with the travel data is calculated in the ticket computer 10. At a time t4, a payment procedure is executed between the ticket computer 10 and the cell phone 14. In the process, an amount of money which is equivalent to the ticket price and is stored in the chip card 22 is deducted in a confirmable fashion. The chip card 22 uses, for example, an internal private digital key to generate an electronic signature following the following data: current date, current time, old amount of money, new amount of money and a random number. The data is transmitted to the ticket computer 10 together with the signature.

The transmitted data is checked using a public digital key associated with the private key. In the process, for example the asymmetricals methods known from cryptography are used, for example the RSA method (Rivest, Shamir and Adleman). The public key is normally stored at what is referred to as a “Trusted Third Party” of a key infrastructure and can be requested there via the Internet, for example. If the signature is genuine, it is ensured that it is actually the chip card 22 of the passenger which is involved and that the data is correct, in particular that the amount of money has been reduced.

At a time t6, the ticket computer 10 generates a confirmation message which is transmitted via the two Bluetooth interfaces 12 and 30 to the cell phone 14 and is stored there in the chip card for later monitoring purposes. In a first exemplary embodiment, the confirmation data includes the travel data signed with a private digital key of the service provider computer 10. In the first exemplary embodiment, the ticket computer 10 can be operated independently of a central service provider computer 34. However, it is prefereable to transmit the travel data to the central service provider computer 34, for example for statistical evaluation, see time t8.

If the amount of money stored on the chip card 22 has been spent, the amount of money can be increased again by setting up a mobile phone link to the payment computer 36 and by means of a subsequently executed top-up method, see time t10.

If the payment computer 36 does not belong to the operator of the underground railroad, the payment transfer between the operator of the payment computer 36 and the operator of the underground railroad is executed using the data transmitted during the payment operation t4.

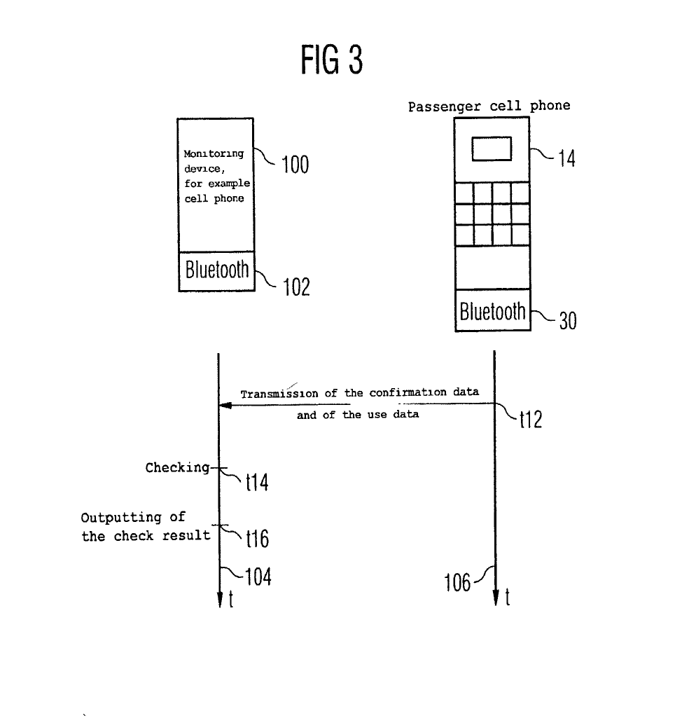

FIG. 3 shows a procedure when monitoring an electronic ticket without involving the mobile phone network 16. A monitoring person makes use here of a monitoring device 100 which has a Bluetooth interface 102. The monitoring device 100 is, for example, a cell phone which has been expanded with monitoring functions. Procedures which take place with the involvement of the monitoring device 100 are represented on a time sequence 104 in FIG. 3. Procedures which are executed with the involvement of the cell phone 14 are represented on the time sequence 106.

The monitoring person requests the passenger to transmit the confirmation data, received at the time t6, from his cell phone 14 to the monitoring device 100. At a time t12, the transmission of the confirmation data is executed via the Bluetooth interfaces 30 and 102. The confirmation data contains the travel data so that at a time t14 the monitoring person can check whether the passenger is authorized to use the means of transportation. For checking purposes, the signature following the travel data is also checked using a digital public key of the operator of the underground railroad. During the checking, the monitoring person will, if appropriate, take into account the monitoring location and the monitoring time. If the monitoring location is permanently predefined, it can be input into the monitoring device 100. In this case, the checking which is to be carried out at the time tl4 can be executed fully automatically. At a time t16, an automatically determined check result is output on a display of the monitoring device 100. Alternatively, at the time t16 the monitoring person himself arrives at a check result. Depending on the check result, the passenger can continue his journey unimpeded if he has a valid electronic ticket. If, on the other hand, his electronic ticket is not valid, or if the passenger does not have an electronic ticket or any other valid ticket, post-payments become due.

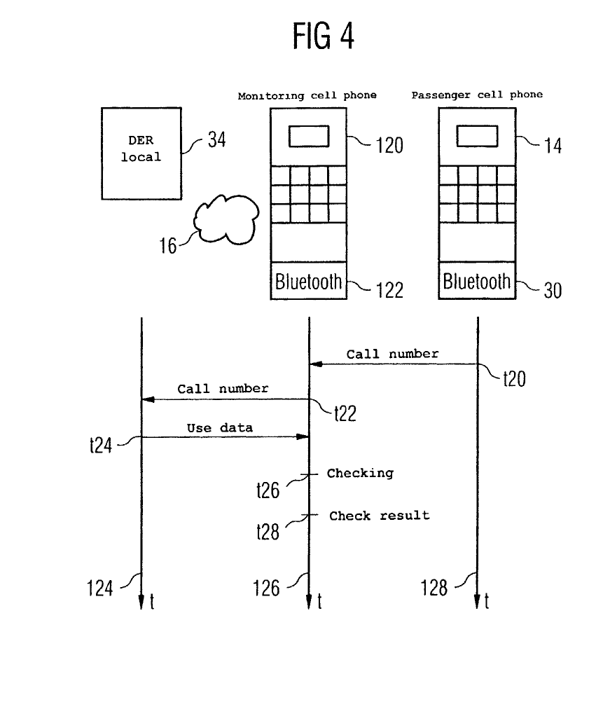

FIG. 4 shows a procedure when monitoring the electronic ticket with the involvement of the mobile phone network 16. The monitoring method explained with reference to FIG. 4 does not presume that confirmation data is stored in the passenger cell phone 14. However, the travel data must be transmitted from the ticket computer 10 to the central service provider computer 34, see FIG. 2, time t8.

In order to carry out the monitoring method explained with reference to FIG. 4, the monitoring person uses a monitoring cell phone 120 which, in addition to the functions of a customary cell phone, has been expanded with the functions for the monitoring process. The monitoring cell phone 120 also has a Bluetooth interface 122.

Procedures which relate to the central service provider computer 34, to the monitoring cell phone 122 and to the passenger cell phone 14 are illustrated in FIG. 4 using three time sequences 124, 126 and 128.

The monitoring person requests the passenger to transfer his cell phone number to the monitoring cell phone 120. At a time t20, the call number R1 of the cell phone 14 is transmitted to the monitoring cell phone 120 via the Bluetooth interfaces 30 and 122. At a following time t22, the call number R1 is transmitted to the central service provider computer 34 via the mobile phone interface of the monitoring cell phone 120 using the mobile phone network 16.

At a time t24, the travel data which is stored in relation to the call number R1 is read and transferred from the service provider computer 34 to the monitoring cell phone 120 via the mobile phone network 16. At a time t26, the monitoring person checks, by reference to the transferred travel data, whether the passenger is authorized to use the means of transportation. The check result is available at a time t28. Depending on the check result, the passenger can continue his journey unimpeded, or a post-payment becomes due. If the location of the monitoring cell phone 120 is known in the monitoring cell phone, the check procedures for the time t26 and t28 can be automatically executed.

In other exemplary embodiments, use is made of ticket computers 10 to which a plurality of Bluetooth interfaces are connected, for example 10 interfaces. Via these interfaces, a plurality of passengers can purchase their tickets simultaneously. The individual Bluetooth interfaces can be connected to the ticket computer via a local data transmission network, see dashed lines 130 in FIG. 1.

In a further exemplary embodiment, the functions of the central service provider computer 34 and of the payment computer 36 are provided by a single computer which belongs to the operator of the underground railroad.

In another exemplary embodiment, when purchasing the ticket the passenger can select whether he would like to use the Bluetooth interface 30 or the mobile phone interface 28 to purchase the ticket.

Instead of the manual inputting of the travel data at the time t0, FIG. 2, in a further exemplary embodiment the travel data is stored in the passenger cell phone and read. Personal, frequently used travel data is therefore stored in the cell phone 14. This measure simplifies the inputting of the travel data considerably as once it has been entered travel data can be used repeatedly.

The inputting of the travel data can, however, also be made easier by providing pre-assignments of push button keys with standard journeys, for example the key 1 for a single journey/adult/into the town center, key 2 for return journey/adult/into the town center, key 3 for a day pass, key 4 for a family pass etc.

What is claimed is:

1. A method for electronically paying for the use of a means of transportation, comprising:
using a terminal of a mobile phone data transmission network;
transmitting, locally, data via the terminal which includes a mobile phone interface and a local interface;
setting up a short-range data transmission link between the terminal and a service provider computer via the local interface;
transmitting use data which indicate the planned use of the means of transportation by the user of the terminal from the terminal to the service provider computer via the short-range data transmission link; and
paying for the use of the means of transportation by means of an electronic payment method using the local interface.

2. The method as claimed in claim 1, wherein
the terminal is assigned a call number which is accessible by other terminals, and
the call number of the terminal is transmitted via the short-range data transmission link and stored with the use data in a central storage unit.

3. The method as claimed in claim 2, wherein
a monitoring data transmission link is set up between a monitoring device and the terminal via the local interface,
the call number of the terminal is transmitted to the monitoring device via the monitoring data transmission link,
a long-distance data transmission link is set up between the monitoring device and a service provider computer with access to the central storage unit,
the call number of the terminal is transferred to the service provider computer via the long-distance data transmission link,
the use data which is stored in relation to the call number is read from the central storage unit in the service provider computer, and
the authorization for actual use of the means of transportation is checked by reference to the read use data.

4. The method as claimed in claim 1, wherein a confirmation relating to confirmation data including the electronic payment method is transmitted by the service provider computer via the short-range data transmission link, and is stored in the terminal.

5. The method as claimed in claim 4, wherein
a monitoring data transmission link is set up between the terminal and a monitoring device via the local interface,
the confirmation data is transmitted from the terminal to the monitoring device via the local interface, and
the authorization for actual use of the means of transportation is checked by reference to the confirmation data.

6. The method as claimed in claim 4, wherein the confirmation data includes the use data.

7. The method as claimed in claim 1, wherein the use data indicates a place of embarkation and and/or a place of disembarkation and/or the number of passengers and/or a number of tariff zones.

8. The method as claimed in claim 1, wherein the use data and/or the confirmation data is encrypted electronically and/or signed electronically.

9. The method as claimed in claim 1, wherein
the local interface is an interface with a short data transmission range, and/or the range lies between approximately one meter and approximately ten meters,
the local interface is a radio interface or an optically functioning interface, and/or
the local interface is an interface which operates according to the Bluetooth standard or according to a standard which is based on the Bluetooth standard.

10. The method as claimed in claim 1, wherein
the data transmission links are set up automatically after the manual inputting of a start signal, and/or
the data is transmitted automatically after the inputting of a manual start signal.

11. The method as claimed in claim 1, wherein
the payment method is a prepayment method or a credit method or a method in which an amount of money which is stored in a memory card of the terminal is reduced, and/or
the call number of the terminal or another identifier of the user of the terminal is used for identification purposes within the scope of the payment method.

12. The method as claimed in claim 1, wherein, depending on a selection date, the use data is transmitted to the service provider computer either via the local interface or via the mobile phone interface.

13. A terminal, comprising:
a mobile phone interface;
a local interface;
and having a control unit, wherein
the control unit is configured such that when the terminal is operating,
data is transmitted locally via the terminal,
a short-range data transmission link is set up between the terminal and a service provider computer via the local interface,
use data which indicate the planned use of the means of transportation by a user of the terminal is transmitted from the terminal to the service provider computer via the short-range data transmission link, and
the use of the means of transportation by means of an electronic payment method is paid using the local interface.

14. A monitoring device, comprising:
a local interface; and
a control unit,
wherein the control unit is configured such that when the monitoring device is operating,
data is transmitted locally via a terminal,
a short-range data transmission link is set up between the terminal and the service provider computer via the local interface,
use data which indicate the planned use of means of transportation by a user of the terminal is transmitted from the terminal to the service provider computer via the short-range data transmission link, and
the use of the means of transportation by means of an electronic payment method is paid using the local interface.

15. A service provider computer, comprising:
a control unit,
wherein, when the service provider computer is operating,
data is transmitted locally via a terminal,
a short-range data transmission link is set up between the terminal and the service provider computer via a local interface,
use data which indicate the planned use of means of transportation by a user of the terminal is transmitted from the terminal to the service provider computer via the short-range data transmission link, and
the use of the means of transportation by means of an electronic payment method is paid using the local interface.
